(19) United States
(12) Patent Application Publication
(10) Pub. No.: US 2019/0250957 A1
(43) Pub. Date: Aug. 15, 2019

(54) SYSTEM AND METHOD OF DYNAMIC ALLOCATION OF HARDWARE ACCELERATOR

(71) Applicant: Hitachi, Ltd., Chiyoda-ku, Tokyo (JP)

(72) Inventors: Keisuke HATASAKI, Kawasaki-city, Kanagawa (JP); Hideo SAITO, San Jose, CA (US)

(21) Appl. No.: 16/310,792

(22) PCT Filed: Dec. 12, 2016
(86) PCT No.: PCT/US16/66228

§ 371 Date: Dec. 17, 2018

(51) Int. Cl. G06F 9/50; G06F 9/48; G06F 9/38

(52) U.S. Cl. CPC G06F 9/5044; G06F 9/5055; G06F 9/3877; G06F 9/4881

(57) ABSTRACT

Example implementations described herein are directed to systems and methods involving a computer server that can include one or more accelerators and processors; a memory configured to manage a first relationship between a software and functions supported by the one or more accelerators, and a second relationship between the software and assigned accelerators; and a function module executed by a processor from the processors, the execution of the function module causing the processor to be configured to, for receipt of an execution of a function from the plurality of functions by a software, determine, from the second relationship, an existence of an assigned accelerator from one or more accelerators for the software from the plurality of software; and determine whether to execute the function on the assigned accelerator or on the processors.

### BACKGROUND

### Field

The present disclosure relates to server resource management, and more specifically, to a method and apparatus for allocating functions to Field Programmable Gate Arrays (FPGAs) of a server based on software running in the server

### Related Art

In related art implementations, FPGAs are implemented for various computer systems in enterprise. For example, FPGA can be used for eliminating the performance bottleneck of the software running in servers. However, improving flexibility by avoiding hardware dependencies is also important in enterprise computer system.

In a related art implementation, FPGA functions of a server can be utilized if the software running in the server can support the function of the FPGA. An example of such a related art implementation can include an open, elastic provisioning of hardware acceleration in a network functions virtualization (NFV) environment.

### SUMMARY

In related art implementations, FPGAs may be not efficiently allocated. Example implementations described herein are directed to methods and apparatuses for allocating functions to the FPGA(s) of a server based on software running in the server.

Aspects of the present disclosure include a system which can involve a computer server. The computer server can include one or more accelerators; one or more processors; a memory configured to manage a first relationship between a plurality of software and a plurality of functions supported by the one or more accelerators, a second relationship between the plurality of software and one or more assigned accelerators from the one or more accelerators; and a function module executed by a processor from the one or more processors, the execution of the function module causing the processor to be configured to, for receipt of an execution of a function from the plurality of functions by a software from the plurality of software, determine, from the second relationship, an existence of an assigned accelerator from one or more accelerators for the software from the plurality of software; and determine whether to execute the function on the assigned accelerator or on the one or more processors.

Aspects of the present disclosure can further include a computer program, storing instructions for executing a process, the instructions including managing a first relationship between a plurality of software and a plurality of functions supported by one or more accelerators; managing a second relationship between the plurality of software and one or more assigned accelerators from the one or more accelerators; for receipt of an execution of a function from the plurality of functions by a software from the plurality of software, determining, from the second relationship, an existence of an assigned accelerator from the one or more accelerators for the software from the plurality of software; and determining whether to execute the function on the assigned accelerator or on one or more processors. The instructions may be stored on a non-transitory computer readable medium.

Aspects of the present disclosure can further include a method, which can include managing a first relationship between a plurality of software and a plurality of functions supported by one or more accelerators; managing a second relationship between the plurality of software and one or more assigned accelerators from the one or more accelerators; for receipt of an execution of a function from the plurality of functions by a software from the plurality of software, determining, from the second relationship, an existence of an assigned accelerator from the one or more accelerators for the software from the plurality of software; and determining whether to execute the function on the assigned accelerator or on one or more processors.

Aspects of the present disclosure can further include an apparatus, which can include means for managing a first relationship between a plurality of software and a plurality of functions supported by one or more accelerators; means for managing a second relationship between the plurality of software and one or more assigned accelerators from the one or more accelerators; for receipt of an execution of a function from the plurality of functions by a software from the plurality of software, means for determining, from the second relationship, an existence of an assigned accelerator from the one or more accelerators for the software from the plurality of software; and means for determining whether to execute the function on the assigned accelerator or on one or more processors.

### BRIEF DESCRIPTION OF DRAWINGS

FIG. 1 illustrates an example of a physical configuration of the system in which the example implementations as described herein may be applied.

FIG. 2 illustrates an example accelerator table, in accordance with an example implementation.

FIG. 3 illustrates a software table, in accordance with an example implementation.

FIG. 4 illustrates an example system configuration table, in accordance with an example implementation.

FIG. 5 illustrates a software repository, in accordance with an example implementation.

FIG. 6 illustrates an example function repository, in accordance with an example implementation.

FIG. 7 illustrates an example flow of the function module, in accordance with an example implementation.

FIG. 8 illustrates an example flow for the function loader, in accordance with an example implementation.

FIG. 9 illustrates an example flow of an assignment manager running in Management server, in accordance with an example implementation.

FIG. 10 illustrates an example flow of function module, in accordance with an example implementation.

FIG. 11 illustrates an example of a job flow defined in the job flow manager, in accordance with an example implementation.

FIG. 12 illustrates an example flow for the job flow manager, in accordance with an example implementation.

### DETAILED DESCRIPTION

The following detailed description provides further details of the figures and example implementations of the present application. Reference numerals and descriptions of redundant elements between figures are omitted for clarity. Terms used throughout the description are provided as examples and are not intended to be limiting. For example, the use of the term “automatic” may involve fully automatic or semi-automatic implementations involving user or administrator control over certain aspects of the implementation, depending on the desired implementation of one of ordinary skill in the art practicing implementations of the present application. Selection can be conducted by a user through a user interface or other input means, or can be implemented through a desired algorithm. Example implementations as described herein can be utilized either singularly or in combination and the functionality of the example implementations can be implemented through any means according to the desired implementations.

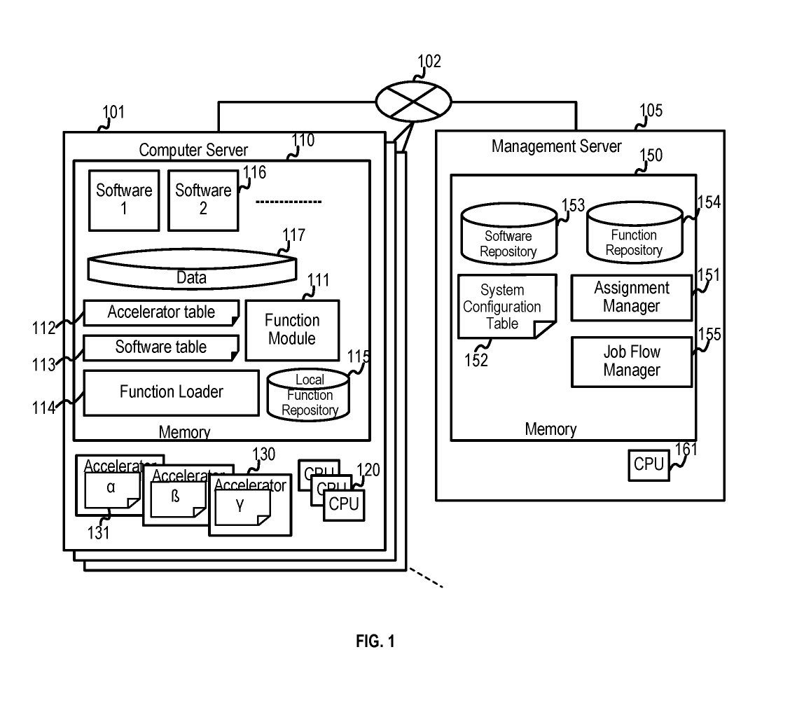

FIG. 1 illustrates an example of a physical configuration of the system in which the example implementations as described herein may be applied. In the example of FIG. 1, the system can include one or servers 101, each of which can include Memory 110, central processing unit (CPU) 120, and accelerator 130. The Memory 110 is configured to store Function module 111, Accelerator table 112, Software table 113, Function loader 114, Local function repository 115, Software 116, and Data 117. CPU can be in the form of one or more physical hardware processors. Accelerator 130 can also be in the form of physical hardware configured to accelerate software processes or execute software functions in hardware form, such as an FPGA.

Management server 105 can include Memory 150 and CPU 161. The Memory 150 is configured to store Assignment manager 151, System configuration table 152, Software repository 153, Function repository 154, and Job flow manager 155. One or more networks 102 can be configured to connect between each of the servers 101 and Management server 105.

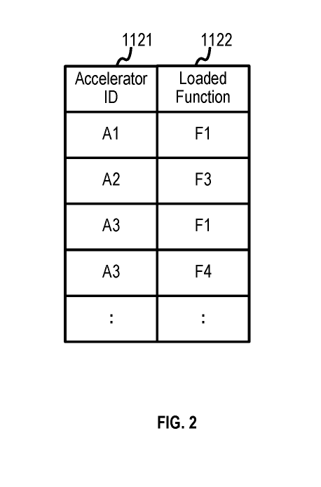

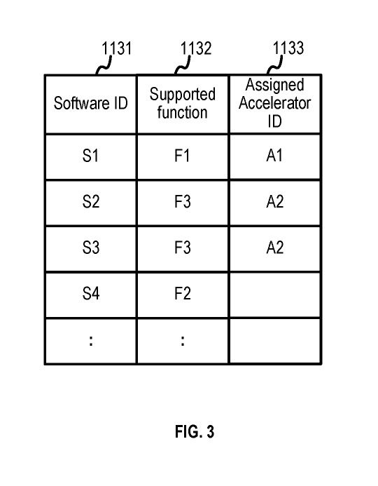

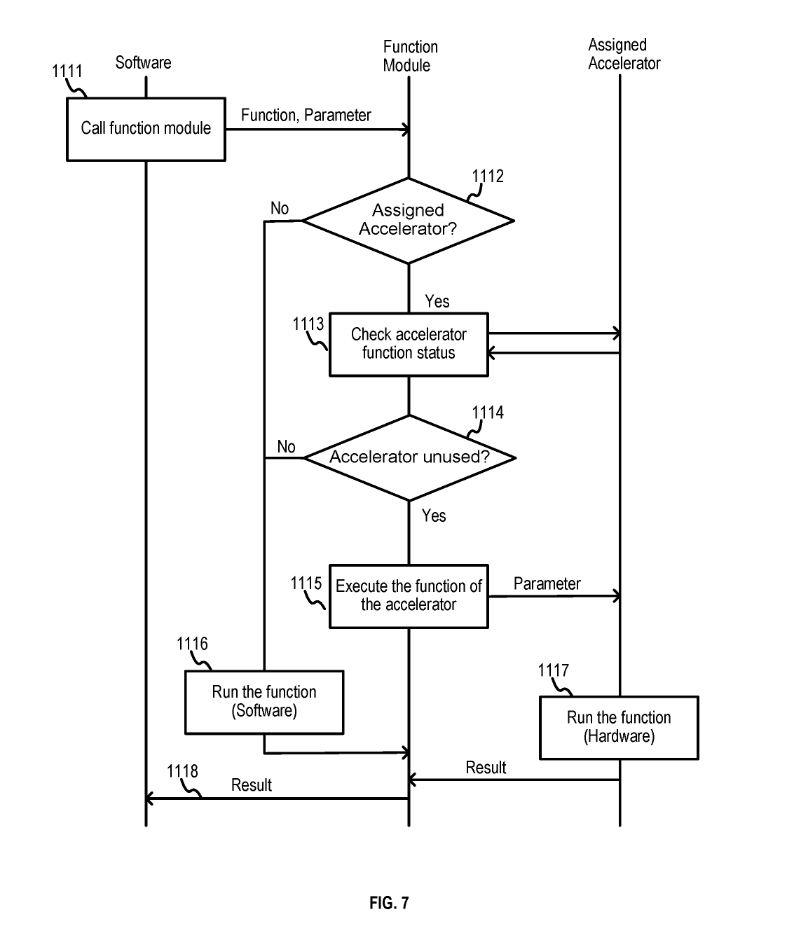

As illustrated in FIG. 1, the one or more computer servers 101 can be configured to manage one or more accelerators 130 and one or more processors 120. Memory 110 can be configured to manage a first relationship between a plurality of software 116 and a plurality of functions supported by the one or more accelerators 131 as illustrated, for example, in FIG. 3 and the software table 113. Memory 110 can also manage a second relationship between the plurality of software 116 and one or more assigned accelerators from the one or more accelerators 130 as defined in the accelerator table 112 and as illustrated in FIG. 2. Function module 111 can be executed by a processor from the one or more processors 120. The execution of the function module 111 can cause the processor to be configured to, for receipt of an execution of a function from the plurality of functions by a software from the plurality of software determine, from the second relationship, an existence of an assigned accelerator from one or more accelerators 130 for the software from the plurality of software 116; and determine whether to execute the function on the assigned accelerator or on the one or more processors 120 by, for example, execution of the flow as described in FIG. 7. The execution of the function module 111 can cause the processor from the one or more processors 120 to be configured to determine whether to execute the function on the assigned accelerator or on the one or more processors based on an availability of the assigned accelerator as shown, for example, at the flow of 1113 and 1114 of FIG. 7.

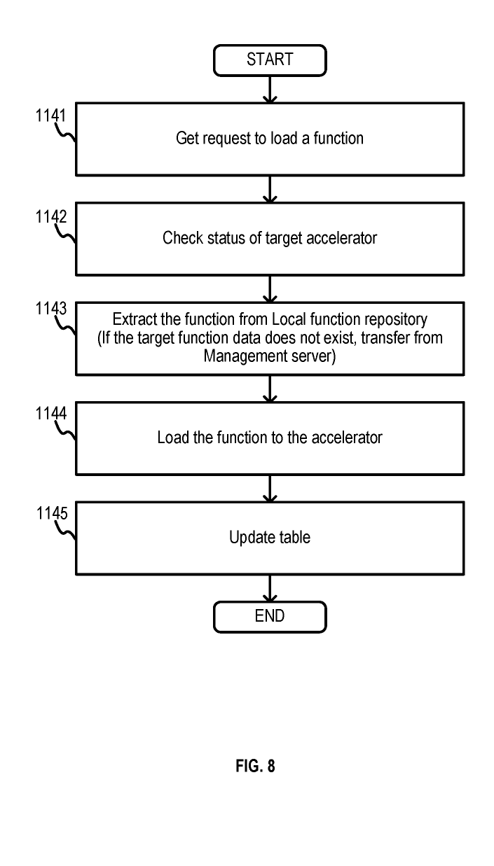

The execution of the function module 111 can cause the processor from the one or more processors 120 to be configured to, for the assigned accelerator determined to exist, disable assignments of the assigned accelerator from other software associated with the assigned accelerator in the second relationship as described in the flows of 1113 to 1115 of FIG. 7, and for the assigned accelerator not having the function from the plurality of functions, load the function into the accelerator from one of a local function repository and a management server and execute the function on the assigned accelerator as described in FIG. 7 and FIG. 8. For the assigned accelerator determined not to exist, the function module 111 can be executed to cause the processor from the one or more processors 120 to be configured to execute the function on the one or more processors 120.

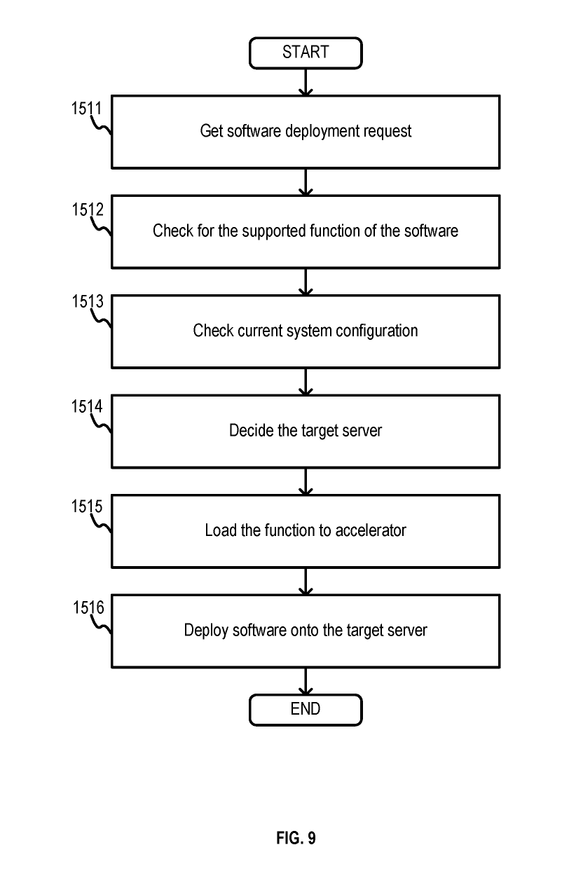

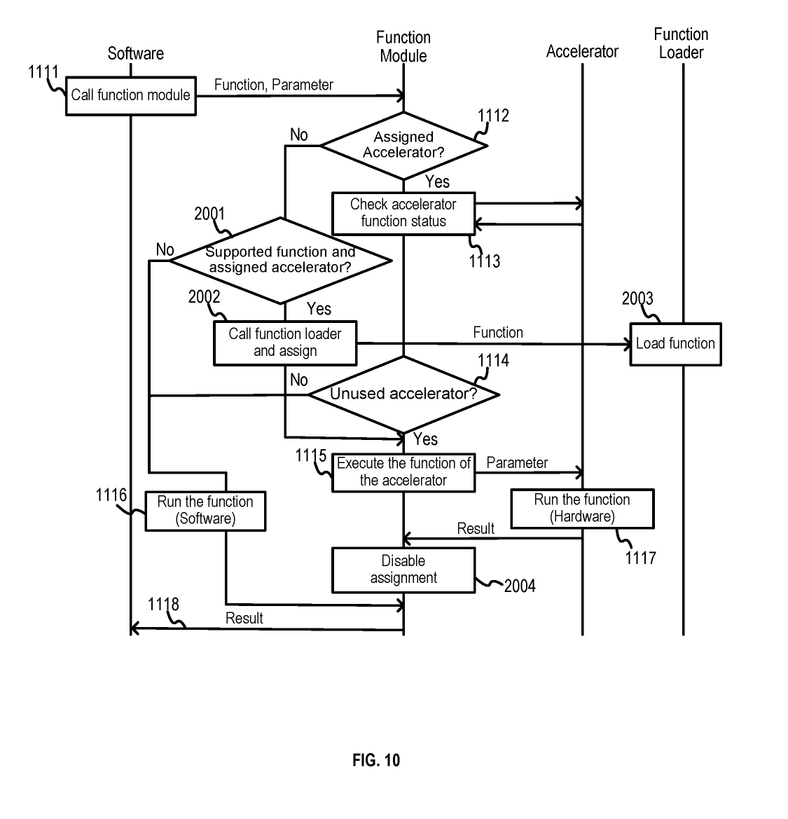

Execution of the function module 111 can also cause the processor from the one or more processors 120 to be configured to, for the determination of the assigned accelerator from one or more accelerators for the software from the one or more software not existing, assign an accelerator from the one or more accelerators and load the function to the accelerator as described, for example, in the flows of FIG. 8 and FIG. 9. Further, the execution of the function module can cause the processor from the one or more processors 120 to be configured to, for the determination whether to execute the function on the assigned accelerator or on the one or more processors being that the function is to be executed on the assigned accelerator, execute the function on the assigned accelerator and unassign the assigned accelerator from the software from the one or more software upon completion of the execution, as described, for example, in the flows of FIGS. 9 and 10.

Management server 105 can be communicatively connected to the computer server 101 via network 102. The management server can include an assignment manager 151, that when executed by a processor 161 of the management server, causes the processor of the management server to be configured to, for a software deployment request associated with the software from the plurality of software, determine whether to execute the function on the assigned accelerator or on the one or more processors based on a system configuration of the computer server and support for the function in the assigned accelerator based on the first relationship; for the determination to execute the function on the assigned accelerator, provide the function from the plurality of functions for loading into the assigned accelerator by the computer server and instruct the computer server to execute the function from the plurality of functions in the assigned accelerator; and for the determination to execute the function on the one or more processors, instruct the computer server to execute the function from the plurality functions on the one or more processors as described, for example, in the flow of FIG. 9.

The execution of the assignment manager 151 can further cause the processor 161 of the management server 105 to be configured to select the computer server as a target server for the software deployment request based on at least one of the first relationship of the computer server and resource capacity of the computer server as described in FIG. 9 at 1514.

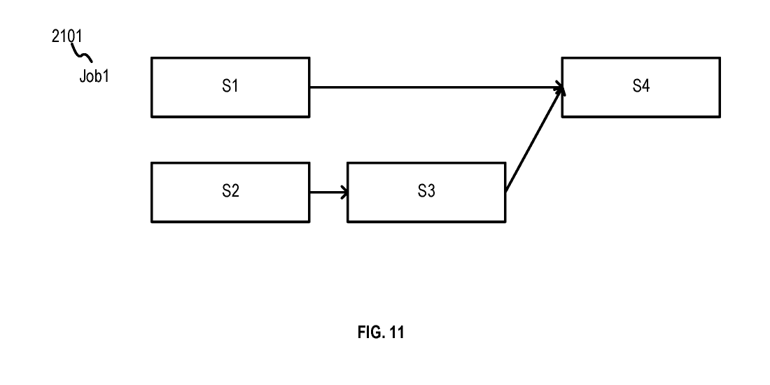

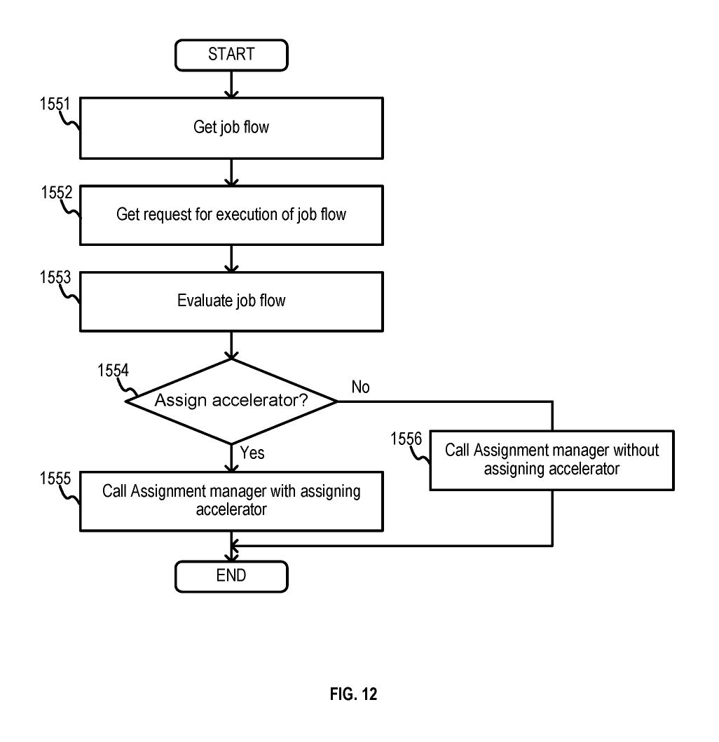

Management server 105 can also include a job flow manager 155 that when executed by the processor 161 of the management server, causes the processor 161 to be configured to evaluate a performance of a requested job flow based on a sequence of the software associated with the job flow and an effect on a function repository; determine whether to assign or not assign an accelerator based on the performance evaluation, and provide the determination to the computer server as described, for example, in FIGS. 11 and 12.

FIG. 2 illustrates an example accelerator table 112, in accordance with an example implementation. Specifically, column 1121 illustrates identifiers for accelerators accessible by the server. Column 1122 illustrates the loaded function in the corresponding accelerator. For example, if the accelerator is a FPGA, the logic data/instructions of the corresponding loaded function is loaded in the FPGA.

FIG. 3 illustrates a software table, in accordance with an example implementation. Specifically, column 1131 illustrates identifiers for the software running on the server. Column 1132 illustrates identifiers for the supported functions of the accelerators. In an example, supported function “F1” indicates that the corresponding software supports the offloading of the function “F1” to the accelerator that has “F1” function loaded. Column 1133 illustrates identifiers of the accelerators that are assigned to the corresponding software. If the value of the column is empty, then no accelerators have been assigned for the corresponding software. From the software table of FIG. 3, a relationship can be maintained by the computer server between a plurality of software as indicated in column 1131 and a plurality of functions supported by the one or more accelerators of the computer server as indicated in column 1132. Further, from the software table of FIG. 3, a relationship can also be maintained by the computer server between the plurality of software as indicated in column 1131 and one or more assigned accelerators from the one or more accelerators of the computer server as indicated in column 1133, to indicate the accelerators assigned to the corresponding software and function.

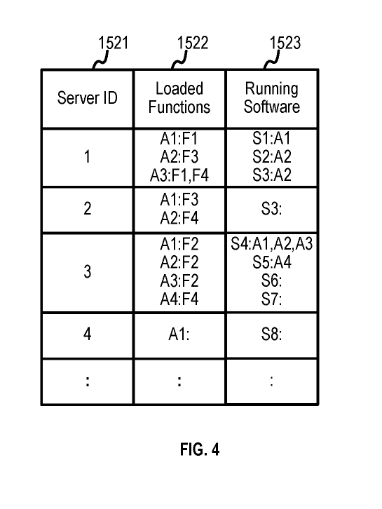

FIG. 4 illustrates an example system configuration table 152, in accordance with an example implementation. Specifically, column 1521 illustrates example server identifiers. Column 1522 illustrates an example list of all accelerators and loaded functions of the accelerators. These values are the same as the values found in Accelerator table 112 for the corresponding server. For clarity, the value “A1:F1” illustrates that function “F1” has been loaded in accelerator “A1”. Column 1523 illustrates a list of running software and the assigned accelerator. These values should be same as the values of software table 113 from the corresponding server. For clarity, the value “S1:A1” indicates that accelerator “A1” has been assigned to software “S1”.

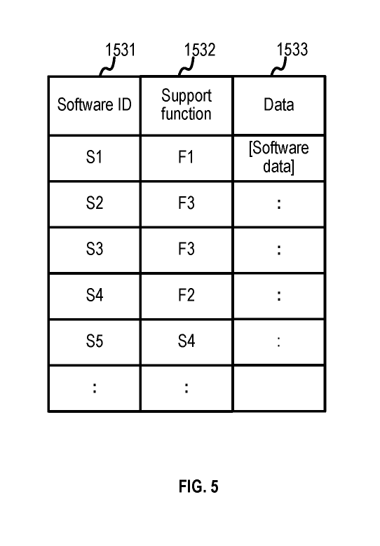

FIG. 5 illustrates a software repository 153, in accordance with an example implementation. Specifically, column 1531 illustrates software identifiers. Column 1532 illustrates identifiers for the supported functions of the accelerators. The configuration of this repository is the same as software table 113, except that this repository stores all software running in the system. Column 1533 illustrates data corresponding to the software of column 1531. The column includes CPU executable function data, code, or image corresponding to function (Column 1532) that the software supported. The data is used for deploying corresponding software to the server.

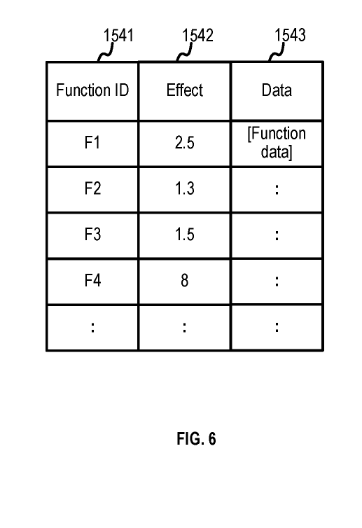

FIG. 6 illustrates an example function repository 154, in accordance with an example implementation. The repository as illustrated in FIG. 6 stores attributes and data of all functions. Column 1541 illustrates function identifiers. Column 1542 illustrates the effect of the corresponding function. The values of column 1542 show expected performance improvement. For example, “2.5” indicates that the performance for processing a function by the corresponding accelerator is 2.5 times better than the CPU. However, such a value may indicate typical or ideal effect for evaluation. Column 1543 illustrates the data for the corresponding function. For example, if the accelerator is a FPGA, the data may include logic data of the function for loading to the FPGA.

In a first example implementation, there is the allocation of a function to an FPGA.

FIG. 7 illustrates an example flow of Function module 111, in accordance with an example implementation. The function module 111 is executed by a processor from the one or more processors of the computer server. The flow begins at 1111, wherein Software 116 calls Function module 111 with a function identifier and parameters when the software starts execution of the function. If there is only one assigned accelerator, the identifier of function could be omitted depending on the desired implementation. The function module 111 thereby receives an execution of a function from the plurality of functions by a software from the plurality of software.

At 1112, a determination is made as to whether the function has been assigned to the software based on Software table 113. That is, based on the relationship between the function and the software as indicated in software table 113, a check is performed for determining if a corresponding assigned accelerator exists. For the accelerator assigned determined to exist (Yes), then the flow proceeds to 1113, otherwise (No), the flow proceeds to 1116 to execute the function on the one or more processors (e.g. in software).

The flow proceeds to determine whether the function should be executed on the assigned accelerator or to the one or more processors (e.g. in software). At 1113, the function module determines whether to execute the function on the assigned accelerator or on the one or more processors based on an availability of the assigned accelerator. A determination is made as to the availability of the accelerator(s) that are assigned to the software. For example, Function Module 111 communicates with Accelerator 130 that is assigned to the software, and the accelerator provides a response as to whether the accelerator is available or unavailable. At 1114, if the response from the accelerator is available (Yes), then the flow proceeds to 1115, otherwise (No), the flow proceeds to 1116.

At 1115, the function of the accelerator is executed with the provided parameter. Then, the accelerator executes the function in hardware at 1117. If the accelerator has its own memory or buffers and requires the storing of data for the function before executing the function, the function module 111 is configured to store the data.

At 1116, the function is executed in software by the CPU. At 1117, the accelerator assigned to the software executes the function. At 1118, the result of the execution is returned to the software.

FIG. 8 illustrates an example flow for function loader 114, in accordance with an example implementation. The flow begins at 1141, wherein a request to load a function is obtained. For example, Assignment Manager 151 or Function Module 111 sends the request with the function identifier and the target accelerator identifier.

At 1142, the function loader checks the status of target accelerator based on Accelerator table 112, Software table 113, and checking availability of the target accelerator. If the function has not been loaded in the target accelerator and the target accelerator is available, then the flow proceeds to 1143. Before proceeding to the flow at 1143, the function loader disables all assignments of the target assigned accelerator from the other software as indicated by the relationships in the software table 113, and updates the Software table 113. If the function has already been loaded in the target assigned accelerator, then the flow ends and the function is executed on the target assigned accelerator.

At 1143, for the assigned accelerator not having the function from the plurality of functions, the function is loaded from one of a local function repository and a management server. The function loader extracts the function data from local function repository. If the function data does not exist in the repository, then the function data will be transferred from Management server by the requesting assignment manager.

At 1144, the function loader loads the function data to the target accelerator. This may be implemented by using a specific interface or method, and implemented depending on the type of accelerator.

At 1145, when the loading process of 1144 is finished, the function loader updates the Accelerator table.

FIG. 9 illustrates an example flow of an Assignment manager 151 running in Management server 150, in accordance with an example implementation. The flow begins at 1511, wherein the assignment manager obtains the software deployment request. Assignment manager may provide an interface such as an application programming interface (API), command line interface (CLI), or graphical user interface (GUI) for the request. The interface can accept parameters such as identifiers for the software, target server, function assignment policy, and so on, according to the desired implementation. The function assignment policy includes whether to assign or not to assign a function corresponding to the software. If the policy specifies to not assign a function to the software, then the flow proceeds to 1514, otherwise the flow proceeds to 1512. At 1512, the assignment manager checks the supported function of the software based on the Software repository 153.

At 1513, the assignment manager checks the current system configuration based on the System configuration table 152. Before this, Assignment manager is configured to update the System configuration table by gathering information of Accelerator table 112 and Software table 113 of each server.

At 1514, the assignment manager decides the target server based on current system configuration gathered from 1513. If the client specifies the target server by using the parameter of the interface provided by the assignment manager from 1511, the target server will be selected. Otherwise, if the target server is not supplied, the assignment manager can consider the following factors to determine the selection of a target server and/or selection of execution of the function on the assigned accelerator or the one or processors:

(1) Capacity of resources (e.g. CPU, Memory, Storage, input/output, other system configurations) is sufficient for running the software.

(2) If the software supports the function of the accelerator, there is unassigned accelerator.

If the parameter of the interface specifies to not assign the function to the software, or if any of the servers do not match the function, then the target server can be considered based on the capacity of resources, and the function is loaded from Function repository 154 and transferred to the Local function repository 115 of the target server, whereupon the flow proceeds to 1516.

At 1515, the assignment manager sends a load request to the function loader 114 of the target server determined at 1514. At 1516, the assignment manager deploys the software onto the target server. For deploying software, Assignment manager and Server may utilize various methods such as the virtual machine, container, application streaming, and so on. In this matter, the function can be provided to the computer server to be loaded into the assigned accelerator by the computer server. Thereupon, the computer server can be instructed to execute the function in the assigned accelerator, thereby providing the determination whether to execute the function in the processors or the assigned accelerator directly to the computer server.

In a second example implementation, there is dynamic function loading available after deploying the software. In this example implementation, when software stops or becomes inactive, the Function module 111 detects the software and disables the assignment of the accelerator of the software and update Software table 113.

FIG. 10 illustrates an example flow of function module 111, in accordance with an example implementation. The difference from the first example implementation is the addition of the flows at 2001, 2002, and 2003 for function loader 114.

At 2001, the function module determines if there is an assigned accelerator. If the software has the supported function and there is an accelerator that has not been assigned to any software (Yes), the flow proceeds to the flow at 2002. Otherwise (No), the flow proceeds to 1116.

At 2002, the function module requests the function loader to load the supported function of the software. At 2003, the function loader loads the function by executing the function loader flow from FIG. 8. At 2004, the function module disables the allocation of the accelerator to the software, and updates software table.

In a third example implementation, there is an optimization of accelerator assignment based on job flow.

FIG. 11 illustrates an example of a Job flow defined in Job flow manager 155, in accordance with an example implementation. This flow can be defined or provided by the user through the use of a GUI, API, CLI, or file or other methods according to the desired implementation. Job1 2101 is an identifier of the job flow. In this job flow, software S1 and the sequence of software S2 and S3 are executed in parallel, then S4 is executed.

FIG. 12 illustrates an example flow for the job flow manager 155, in accordance with an example implementation.

At 1551, the job flow manager obtains a job flow from the client, such as the one described in FIG. 11. At 1552, the job flow manager obtains an execution request of a job flow from client, by GUI, API, CLI, and so on, while specifying the identifier of a job flow. At 1553, the job flow manager evaluates the performance of the job flow based on a sequence of software in the job flow and the effect of function repository 154. In this flow, the job flow manager estimates performance by evaluating whether to assign or not assign cases for each software and also to minimize the number of assigned accelerators for the job flow.

For example, from the use of the greedy algorithm, when a new job is received and there is an unassigned accelerator, the job flow manager assigns the accelerator to the new job. For another example, based on number of paths and the number of inputs or outputs to other jobs, if a job has many paths, then the job get priority to the assigned accelerator.

At 1554, for each software, the job manager determines whether to assign (Yes) or not assign (No) an accelerator based on evaluation in the flow at 1553. If the job manager determines to assign an accelerator (Yes), then the flow proceeds to 1555 to call the assignment manager with the assigning accelerator flow described in FIG. 9. Otherwise (No) the flow proceeds to 1556 to call the assignment manager without assigning an accelerator.

Some portions of the detailed description are presented in terms of algorithms and symbolic representations of operations within a computer. These algorithmic descriptions and symbolic representations are the means used by those skilled in the data processing arts to convey the essence of their innovations to others skilled in the art. An algorithm is a series of defined steps leading to a desired end state or result. In example implementations, the steps carried out require physical manipulations of tangible quantities for achieving a tangible result.

Unless specifically stated otherwise, as apparent from the discussion, it is appreciated that throughout the description, discussions utilizing terms such as “processing,” “computing,” “calculating,” “determining,” “displaying,” or the like, can include the actions and processes of a computer system or other information processing device that manipulates and transforms data represented as physical (electronic) quantities within the computer system's registers and memories into other data similarly represented as physical quantities within the computer system's memories or registers or other information storage, transmission or display devices.

Example implementations may also relate to an apparatus for performing the operations herein. This apparatus may be specially constructed for the required purposes, or it may include one or more general-purpose computers selectively activated or reconfigured by one or more computer programs. Such computer programs may be stored in a computer readable medium, such as a computer-readable storage medium or a computer-readable signal medium. A computer-readable storage medium may involve tangible mediums such as, but not limited to optical disks, magnetic disks, read-only memories, random access memories, solid state devices and drives, or any other types of tangible or non-transitory media suitable for storing electronic information. A computer readable signal medium may include mediums such as carrier waves. The algorithms and displays presented herein are not inherently related to any particular computer or other apparatus. Computer programs can involve pure software implementations that involve instructions that perform the operations of the desired implementation.

Various general-purpose systems may be used with programs and modules in accordance with the examples herein, or it may prove convenient to construct a more specialized apparatus to perform desired method steps. In addition, the example implementations are not described with reference to any particular programming language. It will be appreciated that a variety of programming languages may be used to implement the teachings of the example implementations as described herein. The instructions of the programming language(s) may be executed by one or more processing devices, e.g., central processing units (CPUs), processors, or controllers.

As is known in the art, the operations described above can be performed by hardware, software, or some combination of software and hardware. Various aspects of the example implementations may be implemented using circuits and logic devices (hardware), while other aspects may be implemented using instructions stored on a machine-readable medium (software), which if executed by a processor, would cause the processor to perform a method to carry out implementations of the present application. Further, some example implementations of the present application may be performed solely in hardware, whereas other example implementations may be performed solely in software. Moreover, the various functions described can be performed in a single unit, or can be spread across a number of components in any number of ways. When performed by software, the methods may be executed by a processor, such as a general purpose computer, based on instructions stored on a computer-readable medium. If desired, the instructions can be stored on the medium in a compressed and/or encrypted format.

Moreover, other implementations of the present application will be apparent to those skilled in the art from consideration of the specification and practice of the teachings of the present application. Various aspects and/or components of the described example implementations may be used singly or in any combination. It is intended that the specification and example implementations be considered as examples only, with the true scope and spirit of the present application being indicated by the following claims.

What is claimed is:

1. A system comprising:
a computer server comprising:
one or more accelerators;
one or more processors;
a memory configured to manage:
a first relationship between a plurality of software and a plurality of functions supported by the one or more accelerators, and
a second relationship between the plurality of software and one or more assigned accelerators from the one or more accelerators;
and a function module executed by a processor from the one or more processors, the execution of the function module causing the processor to be configured to, for receipt of an execution of a function from the plurality of functions by a software from the plurality of software:
determine, from the second relationship, an existence of an assigned accelerator from one or more accelerators for the software from the plurality of software; and
determine whether to execute the function on the assigned accelerator or on the one or more processors.

2. The system of claim 1, wherein the function module is configured to determine whether to execute the function on the assigned accelerator or on the one or more processors based on an availability of the assigned accelerator.

3. The system of claim 1, wherein the processor is configured to:
for the assigned accelerator determined to exist:
disable assignments of the assigned accelerator from other software associated with the assigned accelerator in the second relationship;
for the assigned accelerator not having the function from the plurality of functions, load the function into the accelerator from one of a local function repository and a management server; and
execute the function on the assigned accelerator; and
for the assigned accelerator determined not to exist, execute the function on the one or more processors.

4. The system of claim 1, further comprising:
a management server communicatively connected to the computer server, the management server comprising an assignment manager that when executed by a processor of the management server, causes the processor of the management server to be configured to:
for a software deployment request associated with the software from the plurality of software, determine whether to execute the function on the assigned accelerator or on the one or more processors based on a system configuration of the computer server and support for the function in the assigned accelerator based on the first relationship;
for the determination to execute the function on the assigned accelerator, provide the function from the plurality of functions for loading into the assigned accelerator by the computer server and instruct the computer server to execute the function from the plurality of functions in the assigned accelerator;
for the determination to execute the function on the one or more processors, instruct the computer server to execute the function from the plurality functions on the one or more processors.

5. The system of claim 4, wherein the execution of the assignment manager causes the processor of the management server to be configured to select the computer server as a target server for the software deployment request based on at least one of the first relationship of the computer server and resource capacity of the computer server.

6. The system of claim 4, wherein the management server further comprises:
a job flow manager that when executed by the processor of the management server, causes the processor to be configured to:
evaluate a performance of a requested job flow based on a sequence of the software associated with the job flow and an effect on a function repository;
determine whether to assign or not assign an accelerator based on the performance evaluation, and
provide the determination to the computer server.

7. The system of claim 1, wherein the execution of the function module further causes the processor to be configured to:
for the determination of the assigned accelerator from one or more accelerators for the software from the one or more software being not existing, assign an accelerator from the one or more accelerators and load the function to the accelerator.

8. The system of claim 1, wherein the execution of the function module further causes the processor to be configured to:
for the determination whether to execute the function on the assigned accelerator or on the one or more processors being that the function is to be executed on the assigned accelerator, execute the function on the assigned accelerator and unassign the assigned accelerator from the software from the one or more software upon completion of the execution.

9. A non-transitory computer readable medium, storing instructions for executing a process, the instructions comprising:
managing a first relationship between a plurality of software and a plurality of functions supported by one or more accelerators;
managing a second relationship between the plurality of software and one or more assigned accelerators from the one or more accelerators;
for receipt of an execution of a function from the plurality of functions by a software from the plurality of software:
determining, from the second relationship, an existence of an assigned accelerator from the one or more accelerators for the software from the plurality of software; and
determining whether to execute the function on the assigned accelerator or on one or more processors.

10. The non-transitory computer readable medium of claim 9, wherein the determining whether to execute the function on the assigned accelerator or on the one or more processors is based on an availability of the assigned accelerator.

11. The non-transitory computer readable medium of claim 9, the instructions further comprising:
for the assigned accelerator determined to exist:
disabling assignments of the assigned accelerator from other software indicated in the second relationship;
for the assigned accelerator not having the function from the plurality of functions, loading the function into the accelerator from one of a local function repository and a management server; and
executing the function on the assigned accelerator; and
for the assigned accelerator determined not to exist, executing the function on the one or more processors.

12. The non-transitory computer readable medium of claim 9, the instructions further comprising:
for the determination of the assigned accelerator from one or more accelerators for the software from the one or more software being not existing, assigning an accelerator from the one or more accelerators and load the function to the accelerator.

13. The non-transitory computer readable medium of claim 9, the instructions further comprising:
for the determination whether to execute the function on the assigned accelerator or on the one or more processors being that the function is to be executed on the assigned accelerator, execute the function on the assigned accelerator and unassign the assigned accelerator from the software from the one or more software upon completion of the execution.

14. The non-transitory computer readable medium of claim 9, the instructions further comprising:
receiving the function from the plurality of functions for loading into the assigned accelerator from a management server; and
determining whether to execute the function on the assigned accelerator or on one or more processors based on receiving instructions from the management server to execute the function from the plurality of functions in the assigned accelerator or the one or more processors.

15. The non-transitory computer readable medium of claim 14, wherein the instructions from the management server are based on a performance of the assigned accelerator.
